(19) United States
(12) Patent Application Publication
(10) Pub. No.: US 2023/0079687 A1
(43) Pub. Date: Mar. 16, 2023

(54) ALKYLRESORCINOL HOMOLOGUES AS ANTIOXIDANTS

(71) Applicant: The Penn State Research Foundation, University Park, PA (US)

(72) Inventors: Andrew S. ELDER, University Park, PA (US); Ryan J. ELIAS, University Park, PA (US); John N. COUPLAND, University Park, PA (US); Helene HOPFER, University Park, PA (US)

(73) Assignee: The Penn State Research Foundation, University Park, PA (US)

(21) Appl. No.: 17/900,503

(22) Filed: Aug. 31, 2022

Related U.S. Application Data
(60) Provisional application No. 63/260,774, filed on Aug. 31, 2021.
(60) Provisional application No. 63/263,483, filed on Nov. 3, 2021.

(51) Int. Cl. A23L 3/349; A21D 13/80; A23D 9/06

(52) U.S. Cl. CPC A23L 3/349; A21D 13/80; A23D 9/06; A23V 2002/00

(57) ABSTRACT

Alkylresorcinols (ARs) are a homologous series of natural phenolipids extracted from rye bran which have shown antioxidant activity in bulk oils and oil-in-water emulsions. This application is directed to their use in low-moisture foods using crackers as a model system. ARs (153 μmol) inhibited lipid oxidation reactions based on delayed formation of primary and secondary products of lipid oxidation compared to a control treatment, and were more effective than α-tocopherol. The antioxidant activity of ARs of compound of Formula (I) increased as alkyl chain length increased, with optimum activity at alkyl chain length C23:0. There was no effect of alkyl chain length on rate of AR loss. ARs are effective antioxidants in low-moisture foods likely due to their hydrophobic nature, which allowed them to localize in the lipid phase, the purported site of lipid oxidation in the model cracker system.

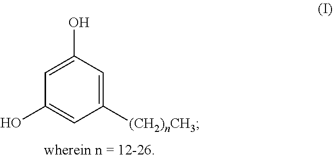

### CROSS-REFERENCE TO RELATED APPLICATIONS

This application claims the benefit of U.S. Provisional Patent Application No. 63/260,774, filed on Aug. 31, 2021, and U.S. Provisional Patent Application No. 63/263,483, filed on Nov. 3, 2021, both of which are incorporated by reference as if fully rewritten herein.

### GOVERNMENT SUPPORT

This invention was made with government support under Grant No. 2018-67011-28010 awarded by the United States Department of Agriculture/NIFA and under Hatch Act Project Nos. PEN04522 and PEN04708 awarded by the United States Department of Agriculture/NIFA. The Government has certain rights in the invention.

### TECHNICAL FIELD

This application is directed to antioxidant compositions comprising alkylresorcinol homologues in low-moisture foods, methods of their preparation, products and uses thereof.

### BACKGROUND

The consumption of omega-3 fatty acids is associated with reducing the incidence of cardiovascular and inflammatory diseases, which has led to the food industry supplementing foods with omega-3s to confer these health benefits. One drawback to this is that these polyunsaturated fatty acids are highly labile to lipid oxidation, resulting in their breakdown and the loss of these health promoting benefits as well as the development of off-flavors. Antioxidants are often added to lipid-containing foods to slow the rate of oxidation, thus preserving omega-3s and their health benefits; however, concerns surrounding the toxicity and consumer acceptability of synthetic antioxidants has resulted in the need to identify and improve the efficacy of natural antioxidants.

Consumers of Western diets tend to overconsume saturated fats, which can have various detrimental effects on health including increasing the risk of developing coronary heart disease (Mozaffarian, Micha, & Wallace, 2010; Shan et al., 2019). Low-moisture foods (a_{w}<0.5), such as cookies, crackers, and granola bars, are a major source of saturated fats in the diet with these grain-based snacks and desserts constituting one of the top three sources of saturated fats for children, aged 2-18 years, consuming Western diets (Huth, Fulgoni III, Keast, Park, & Auestad, 2013; Keast, Fulgoni III, Nicklas, & O'Neil, 2013; Reedy & Krebs-Smith, 2010).

Many foods are naturally prone to chemical degradation via lipid oxidation; however, this has only been exacerbated by the fact that the food industry has begun to reformulate various food products to replace saturated fatty acids with beneficial polyunsaturated fatty acids (Ganesan, Brothersen, & McMahon, 2014). One drawback to this is that polyunsaturated fatty acids are more prone to lipid oxidation due to their high degree of unsaturation. Lipid oxidation results in the loss of a food's nutritional value, the formation of toxic compounds, and the development of off-flavors associated with rancidity (Arab-Tehrany et al., 2012; Frankel, 1998; Jacobsen, Let, Nielsen, & Meyer, 2008; Kanner, 2007). One reported means to control lipid oxidation is through the addition of antioxidants that can rapidly react with prooxidants via a variety of mechanisms (Choe & Min, 2009).

While mechanisms of antioxidant action are well understood, the effect of a given food product's physical structure on antioxidant reactivity is less clear. Progress has been made to understand the effect of structure on lipid oxidation in oil-in-water emulsions and to a lesser extent in bulk oils; however, structural effects in low-moisture foods are not well studied. One important factor may be that prooxidants and antioxidants have reduced molecular mobility in low-moisture foods which limits their interactions, potentially impacting lipid oxidation (Barden & Decker, 2016). For example, many low-moisture foods are fortified with transition metals (e.g. iron) for nutritional purposes, despite this, these ions do not appear to be important prooxidants due to their low mobility (Barden & Decker, 2016; Barden, Vollmer, Johnson, & Decker, 2015).

A second structural factor that may be important in controlling lipid oxidation in low-moisture foods may be the nature of the interface between the lipid phase and other food components present. In bulk oils and high-moisture foods, lipid oxidation occurs at the lipid-water interface; however, this interface is not present in low-moisture foods. (Chen, McClements, & Decker, 2011; Waraho, McClements, & Decker, 2011).

In a low-moisture model cracker system, lipids were observed to form a continuous matrix that surrounds starch granules creating protein-starch-lipid, lipid-air, protein-lipid, and starch-lipid interfaces which may influence the progression of lipid oxidation (Barden, Vollmer, et al., 2015). These observations suggest that the antioxidant strategies required to extend the induction period of lipid oxidation and, thus, increase the shelf life of low-moisture foods, will differ greatly from those utilized in bulk oils and high-moisture foods.

Antioxidants that localize to lipid interfaces are thought to be more effective than antioxidants that localize to other phases because they are concentrated at the site where lipid oxidation occurs (Frankel, Huang, Kanner, & German, 1994). However, this approach is less clear in low-moisture systems where the nature of the interfaces is less well defined and antioxidants may become immobilized in the non-lipid matrix.

One strategy that has been used to enhance the effectiveness of polar antioxidants in oil-in-water emulsions is to graft them with alkyl moieties to increase their hydrophobicity and, thus, their surface activity, driving them to the lipid-water interface (Laguerre et al., 2015). A similar approach was taken using rosmarinic acid and a pair of rosmarinate alkyl esters in a low-moisture model cracker system, where it was found that the hydrophobic eicosyl ester displayed stronger antioxidant activity than rosmarinic acid and the dodecyl ester (Barden, Barouh, Villeneuve, & Decker, 2015). Based on these results, the lipid interfaces were hypothesized to be the sites of lipid oxidation in low-moisture foods, with hydrophobic antioxidants concentrating at the lipid phase, improving their efficacy (Barden, Barouh, et al., 2015).

Due to perceived consumer demand, the food industry is actively attempting to replace synthetic antioxidants with natural alternatives (Brewer, 2011; Gülçin, 2012). Therefore, while modulating hydrophobicity by modifying alkyl chain length has been shown to improve the efficacy of natural antioxidants, this strategy is unlikely to be implemented in the food industry because the resulting products are no longer considered to be “natural.”

Alkylresorcinols (ARs) are a naturally occurring homologous series of amphiphilic phenolipids derived from the bran layer of cereal grains (Bartfomiej, Justyna, & Ewa, 2012). ARs are meta-substituted dihydroxyl phenolics with an odd numbered alkyl chain ranging in length from 13 to 27 carbons (Bartlomiej et al., 2012). The alkyl chains are predominately saturated but can be monounsaturated, di-unsaturated, or contain hydroxyl or ketone groups.

### SUMMARY

Despite being present in many grain-based foods, the antioxidant activity of ARs in low-moisture foods has yet to be studied comprehensively. We report novel methods for use of alkylresorcinols as antioxidants. Some embodiments are directed to use of AR homologues of different alkyl chain lengths, either alone or in a mixture of two or more chain lengths (for example C17:0, C19:0, C21:0, C23:0, C25:0) as antioxidants in a low-moisture food, such as a low-moisture model cracker system.

Additionally, exemplary embodiments may relate to use of individual alkylresorcinol homologues and alpha-tocopherol used in unison, to determine if synergy exists between the two antioxidants, the possible underlying mechanism, and whether this combination improves the efficacy of these natural antioxidants.

According to an exemplary embodiment, there is provided an antioxidant composition comprising:
(i) a compound of Formula (I):

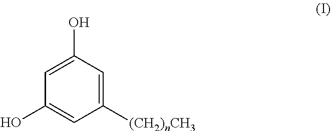

comprising an alkyl chain wherein n=12-26; and
(ii) a low-moisture food;

wherein the low-moisture food has a water activity (a_{w}) equal to or less than 0.85. In another exemplary embodiment the low-moisture food has a water activity equal to or less than 0.5.

In another exemplary embodiment is presented a method of preparing the compound of Formula (I) by winterization, comprising one or more of the following steps:
(i) extracting crude alkylresorcinols from rye bran;
(ii) removing bran solids to produce a crude rye bran extract;
(iii) reconstituting the crude rye bran extract in a solvent;
(iv) centrifuging and retaining a supernatant formed;
(v) storing the supernatant at conditions causing the crude alkylresorcinols to crystallize;
(vi) centrifuging and retaining a pellet formed;
(vii) reconstituting the pellet in alcohol;

optionally repeating steps (i)-(vii) one or more times;

and optionally drying the pellet produced by step (vii).

In another exemplary embodiment is presented a method of preparing the compound of Formula (I) by winterization, comprising one or more of the following steps:
(i) extracting crude alkylresorcinols from rye bran;
(ii) removing bran solids by vacuum filtration to produce a crude rye bran extract;
(iii) reconstituting the crude rye bran extract in a solvent, for example methanol;
(iv) centrifuging at 1700×g for 5 minutes at 20° C., and retaining a supernatant formed;
(v) storing the supernatant at −80° C. for 24 hours, causing the crude alkylresorcinols to crystallize;
(vi) centrifuging at 1700×g for 3 minutes at −9° C. and retaining a pellet formed;
(vii) reconstituting the pellet in methanol;
optionally repeating steps (i)-(vii) one or more times;
and optionally drying the pellet produced by step (vii).

In another exemplary embodiment, there is provided a food product comprising an antioxidant composition disclosed herein.

Other aspects and advantages of the disclosure will be apparent from the following detailed description and the appended claims.

### BRIEF DESCRIPTION OF DRAWINGS

FIG. 1 Effect of 153 μmol (▪) control (no added antioxidant), (♦) orcinol, (□) C17:0, (⋄) C19:0, (Δ) C21:0, (◯) C23:0, (x) C25:0, (+) AR Mix, (▴) α-tocopherol, and (●) BHT on the formation of lipid hydroperoxides in crackers. Data points represent means (n=3)±standard errors. Some error bars are within data points.

FIG. 2 Effect of 153 μmol (▪) control (no added antioxidant), (♦) orcinol, (□) C17:0, (ð) C19:0, (Δ) C21:0, (◯) C23:0, (x) C25:0, (+) AR Mix, (▴) α-tocopherol, and (●) BHT on the formation of headspace hexanal in crackers. Data points represent means (n=3)±standard errors. Some error bars are within data points.

FIG. 3A and FIG. 3B. Induction period of the formation of lipid hydroperoxides (Threshold Concentration: 0.1 mM/g cracker) (FIG. 3A) and headspace hexanal (Threshold Concentration: 1.0 mM/g cracker) (FIG. 3B) in crackers. Bars represent means (n=3)±standard deviations. Bars (within the same lipid oxidation product) with the same letter are not significantly different (α═0.05).

FIG. 4. Loss of (□) C17:0, (ð) C19:0, (Δ) C21:0, (o) C23:0, and (x) C25:0 during storage of the AR Mix-treated cracker. Data points represent means (n=3)±standard errors. Some error bars are within data points.

### DETAILED DESCRIPTION

### Definitions

While the terms used herein are believed to be well understood by one of ordinary skill in the art, definitions are set forth herein to facilitate explanation of the subject matter disclosed herein.

Unless defined otherwise, all technical and scientific terms used herein have the same meaning as commonly understood by one of ordinary skill in the art to which the subject matter disclosed herein belongs. Although any methods, devices, and materials similar or equivalent to those described herein can be used in the practice or testing of the presently disclosed subject matter, representative methods, devices, and materials are described herein.

The terms “a,” “an,” and “the” refer to “one or more” when used in this application, including the claims. The use of the word “a” or “an” when used in conjunction with the term “comprising” in the claims and/or the specification may mean “one,” but it is also consistent with the meaning of “one or more,” “at least one,” and “one or more than one.”

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and devices of the present disclosure, including components thereof, can comprise, consist of, or consist essentially of the essential elements and limitations of the embodiments described herein, as well as any additional or optional components or limitations described herein or otherwise useful.

The term “alkyl” includes branched, straight chain and cyclic, substituted or unsubstituted saturated aliphatic hydrocarbon groups. Alkyl groups can comprise about 1 to about 30 carbon atoms (“C1-C30”), about 16 to 20 carbon atoms, or about 1 to 24 carbon atoms. Examples of alkyl groups include, but are not limited to, methyl, ethyl, propyl, isopropyl, butyl, sec-butyl, tert-butyl, pentyl, isopentyl, neopentyl, hexyl, isohexyl, cyclohexyl, cyclohexylmethyl, cyclopropylmethyl and neohexyl radicals.

The term “aryl” includes a 6- to 14-membered monocyclic, bicyclic or tricyclic aromatic hydrocarbon ring system. Examples of an aryl group include phenyl and naphthyl.

The term “aralkyl” refers to an aryl-alkyl group wherein aryl and alkyl are as previously described.

The term “low moisture food” refers to wherein the food has a water activity (a_{w}) equal to or less than 0.85. Preferably, a_{w} is between 0.6-0.85. In one aspect, a_{w} is 0.6 or less. In a further aspect, a_{w} is 0.6. Preferably, 0.5 or less. Low moisture foods are known to generally be less susceptible to microbial spoilage and growth of foodborne pathogens. Examples of foods that may be low moisture foods include but are not limited to cookies, crackers, granola bars, breakfast cereals, grains, confectionary such as chocolate and cocoa, dairy and egg powders, dried fruits, vegetables and meats, honey, seeds, nuts, peanut butter, chips and other snacks, and spices, for example.

Natural antioxidants normally include tocopherols, phospholipids, ascorbic acid (Vitamin C), phytic acid, phenolic acids, for example. Common synthetic antioxidants for edible use are butylated hydroxyanisole (BHA), butylated hydroxytoluene (BHT), propyl gallate (PG), tertiary butyl hydroquinone (TBHQ), etc. In one embodiment, the composition disclosed herein further comprises any one or more of a natural antioxidant and/or a synthetic antioxidant.

Using a homologous series of ARs in bulk oils and oil-in-water emulsions, we observed that ARs were able to inhibit lipid oxidation reactions in both systems. In addition to this, ARs have been shown to function as free radical scavenging antioxidants but not metal chelating antioxidants.

According to an exemplary embodiment, there is provided an antioxidant composition comprising:

(i) a compound of Formula (I):

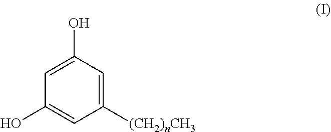

comprising an alkyl chain wherein n=12-26; and

(ii) a low-moisture food;

wherein the low-moisture food has a water activity (a_{w}) equal to or less than 0.85.

In an exemplary aspect, the low-moisture food is manufactured.

In another exemplary aspect, the compound of Formula (I) is isolated, purified, and/or extracted.

In a further exemplary aspect, the compound of Formula (I) is obtained by a winterization process. For example, a forced crystallization process.

In yet another exemplary aspect, the natural abundance of the compound of Formula (I) is low. For example, between 0.004% to 0.32% alkylresorcinols per unit of dry matters low.

In an exemplary aspect, the composition comprises a mixture of compounds of Formula (I).

In a further exemplary aspect, the mixture comprises compounds of Formula (I) in which n=is 12, 14, 16, 18, 20, 22, 24, or 26.

In yet a further exemplary aspect, n=14-20, preferably, n=14, 16, 18, or 20, in the compound of Formula (I). In a yet still further aspect, n=16-24. In a further aspect n=14-24. In a yet still further exemplary aspect, n=16-20 and 22-24. In yet another aspect n=14-20 and 22-24.

In another exemplary aspect, the low moisture food is selected from any one or more of: cookies, crackers, granola bars, breakfast cereals, grains, confectionary such as chocolate and cocoa, dairy and egg powders, dried fruits, vegetables, meats, honey, seeds, nuts, peanut butter, chips, corn chips, potato chips, and other snacks, and spices.

In an exemplary aspect, the a_{w} is 0.6 or less, for example 0.5 or less.

In another exemplary aspect, the composition comprises more than one compound of Formula (I), for example two, three, four, five compounds of Formula (I).

In an exemplary aspect, the alkyl chain length is C₂₁₋₂₃. For example, C₂₁ or C23. In another exemplary aspect, n, which is the alkyl chain length not including the terminal hydrocarbon, is 12-20 or 22-26.

In an exemplary embodiment, the composition of the application further comprises a second type of antioxidant, for example a synthetic or natural antioxidant, such as α-tocopherol and/or BHT.

In an exemplary aspect, the alkyl chain in the compound of Formula (I) is further substituted, for example by a further alkyl, aryl, araryl, unsaturated alkyl, or a carbonyl group.

The present application is also directed to the use of the compositions.

Thus, in another exemplary embodiment, there is provided iutilizing the composition as a preservative.

In another exemplary embodiment is presented a method of preparing the compound of Formula (I) by winterization, comprising one or more of the following steps:
(i) extracting crude alkylresorcinols from rye bran;
(ii) removing bran solids by vacuum filtration to produce a crude rye bran extract;
(iii) reconstituting the crude rye bran extract in an aqueous solvent, for example methanol;
(iv) centrifuging at 1700×g for 5 minutes at 20° C., and retaining a supernatant formed;
(v) storing the supernatant at −80° C. for 24 hours, causing the crude alkylresorcinols to crystallize
(vi) centrifuging at 1700×g for 3 minutes at −9° C. and retaining a pellet formed;
(vii) reconstituting the pellet in methanol;
optionally repeating steps (i)-(vii) one or more times;
and optionally drying the pellet produced by step (vii). Typically these steps are performed in the order stated above.

In a further exemplary aspect, the (i) extracting step of the method disclosed herein uses acetone at a ratio of 1:40 (w/v) by continuous stirring at room temperature for 24 hours; and optionally the acetone is evaporated from the extract to dryness, for example under vacuum at 35° C. using a rotary evaporator. Those of skill in the art will recognize that other extraction and drying methods may be used. For example, rye bran is extracted with acetone using a sample to solvent ratio of 1:40 (w/v) for 24 h with continuous agitation. Insoluble bran components are removed by vacuum filtration, and the acetone is dried. The crude extract is then reconstituted using methanol, followed by centrifugation and recovery of supernatant. ARs are crystallized from the solubilized extract. The extract may be further centrifuged to afford a pellet, which can be solubilized in methanol, and winterization may be twice repeated to further purify the ARs. The final winterized extract can be brought to dryness.

In another exemplary aspect of the application, is provided a low-moisture food obtainable by the method disclosed herein, wherein the compound of formula (I) has a C₁₇₋₂₅ alkyl chain, and is optionally further isolated from the winterized rye bran extract using preparative HPLC.

In an exemplary embodiment, there is provided a food product comprising the composition disclosed herein.

The following description is of further exemplary embodiments that are presently contemplated for carrying out exemplary embodiments reported herein. This description is not to be taken in a limiting sense, but is made merely for the purpose of describing the general principles and features of the present disclosure. The scope of the present disclosure is not limited by this description.

Typical embodiments are directed to compounds of Formula (I) and methods of making them.

### EXPERIMENTAL: MATERIALS AND METHODS

Rye bran (Secale cereale) was donated by Snavely's Mill (Lititz, Pa., U.S.) and had a mean particle size of 1.41 mm or larger. Interesterified soybean oil (ISO) #762420 (Total Unsaturated Fatty Acid Content: 55.0%, Free Fatty Acid Content: 0.028%, Peroxide Value: 0.00 meq/kg) was donated by ADM (Chicago, Ill., U.S.). White rye flour (King Arthur Baking Company, Norwich, Vt., U.S.), iodized salt (Morton, Chicago, Ill., U.S.), and baking soda (Arm & Hammer, Ewing, N.J., U.S.) were purchased from a local grocery store (State College, Pa., U.S.). Dry goods were stored in resealable plastic freezer bags and kept refrigerated (4° C.) while ISO was kept frozen (−20° C.) until use. All other reagents were purchased from Sigma Chemical Company (St. Louis, Mo., U.S.) and were analytical grade or purer.

### Example 1: Extraction and Purification of Alkylresorcinols

ARs were extracted from rye bran according to a method described previously (Elder, Coupland, & Elias, 2019). Briefly, rye bran (20 g) was extracted with acetone at a ratio of 1:40 (w/v) by continuous stirring at room temperature for 24 hours (Gunenc, HadiNezhad, Farah, Hashem, & Hosseinian, 2015). Bran solids were removed by vacuum filtration and the acetone extract was evaporated to dryness under vacuum at 35° C. using a rotary evaporator (Rotavapor R-210, Buchi, Flawil, Switzerland). The crude rye bran extract was reconstituted in methanol, centrifuged at 1700×g for 5 minutes at 20° C. (Centrifuge 5810 R, A-4-62 Rotor, Eppendorf, Hamburg, Germany), and the supernatant was retained. The supernatant was stored at −80° C. for 24 hours, causing the ARs to crystallize, then centrifuged at 1700×g for 3 minutes at −9° C. and the pellet was retained. The pellet was reconstituted in methanol and the winterization procedure of the partially purified rye bran extract was repeated twice to further purify the ARs. After the final winterization procedure, the winterized rye bran extract was dried under a stream of nitrogen and stored at −80° C. until use.

### Example 2: Preparation of Individual Alkylresorcinol Homologues

Individual AR homologues (C17:0, C19:0, C21:0, C23:0, C25:0) were isolated from the winterized rye bran extract using preparative HPLC. Dry, winterized rye bran extract was reconstituted in methanol at a concentration of 40 mg/mL. The preparative HPLC system consisted of a binary pumping system (PrepStar SD-1, Agilent, Santa Clara, Calif., U.S.) with high-pressure mixing and sample introduction by means of manual injection (1 mL). AR homologues were separated on a Viva C18 column (5 μm, 250×10 mm) (Restek, Bellefonte, Pa., U.S.) held at ambient temperature. The mobile phase consisted of water (A) and methanol (B). A gradient program was followed to separate the different AR homologues at a flow rate of 4.0 mL/min. The gradient program was as follows: 0 minutes, 90% B; 0-10 minutes, 100% B; 10-25 minutes, 100% B; 25-25.5 minutes, 90% B; 25.5-35 minutes, 90% B (Gunenc et al., 2015). Detection of the AR homologues was achieved using a UV-Vis detector (ProStar 325, Agilent, Santa Clara, Calif., U.S.) at 280 nm. Individual AR homologues were collected using a fraction collector (440-LC Fraction Collector, Agilent, Santa Clara, Calif., U.S.) with 0.5-minute fractions collected from 10-28 minutes. Chromatograms were reviewed after each run and fractions containing the same AR homologue were combined and stored at −80° C. until use.

### Example 3

The individual AR homologue fractions (C17:0, C19:0, C21:0, C23:0, C25:0) were evaporated to dryness under vacuum at 35° C. using a rotary evaporator (Rotavapor R-210, Buchi, Flawil, Switzerland). The individual AR homologues were reconstituted in methanol and stored at −80° C. for 24 hours, causing the ARs to crystallize, then centrifuged at 1700×g for 3 minutes at −9° C. (Centrifuge 5810 R, A-4-62 Rotor, Eppendorf, Hamburg, Germany) and the pellet was retained. The pellet was reconstituted in methanol and the winterization procedure of the partially purified individual AR homologues was repeated twice to further purify the ARs. After the final winterization procedure, the individual AR homologues were dried under a stream of nitrogen and stored at −80° C. until use.

### Example 4

A small mass of each dried AR homologue was dissolved in methanol to produce stock solutions and analyzed using HPLC to determine purity and concentration. Samples were prepared for HPLC analysis by filtering them over polytetrafluoroethylene (PTFE) syringe filter tips (0.45 μm). The HPLC system consisted of a binary pumping system (LC-10ADvp, Shimadzu, Kyoto, Japan) with high-pressure mixing and sample introduction by means of an autosampler (SIL 10ADvp, Shimadzu, Kyoto, Japan). AR homologues were separated on an Eclipse Plus C18 column (5 μm, 2.1×150 mm) (Agilent, Santa Clara, Calif., U.S.) held at 35° C. The mobile phase consisted of 0.1% (v/v) formic acid in water (A) and 0.1% (v/v) formic acid in methanol (B). A gradient program was followed to separate the different AR homologues at a flow rate of 0.2 mL/min. The gradient program was as follows: 0 minutes, 90% B; 0-10 minutes, 100% B; 10-25 minutes, 100% B; 25-25.5 minutes, 90% B; 25.5-35 minutes, 90% B (Gunenc et al., 2015). Detection and quantification of the AR homologues was achieved using a UV-Vis detector (SPD-10Avp, Shimadzu, Kyoto, Japan) at 280 nm and triple quadrupole mass spectrometer (Micromass Quattro Micro, Waters, Milford, Mass., U.S.) coupled to the HPLC. Mass spectra were collected in negative-ion mode using electrospray ionization (ESI). ESI capillary spray was held at 2.60 kV. Cone source voltage was set to 33 V and source temperature was set to 120° C. Desolvation gas (nitrogen) flow was 450 L/h. Selective ion monitoring was used to monitor ions with m/z of 123.0 (orcinol), 347.3 (C17:0), 375.3 (C19:0), 403.4 (C21:0), 431.4 (C23:0), and 459.4 (C25:0). AR homologues were quantified based on a standard curve prepared for orcinol using the integrated peak areas of the UV chromatograms as previous research has shown that absorbance at 280 nm is due only to the aromatic ring and not the alkyl chain of the AR homologue (Hengtrakul, Lorenz, & Mathias, 1991). The concentration of each individual AR homologue stock solution varied based on the mass used to prepare the stock solution, however, different volumes of the stock solutions were used to achieve the same final concentration of ARs in the ISO and hence in the crackers.

### Example 5: Preparation of Antioxidant-Treated Interesterified Soybean Oil

Based on the concentrations of the individual AR stock solutions previously determined, an appropriate volume, containing 153 μmol of the respective individual AR homologue, was measured into plastic centrifuge tubes to prepare individual AR homologue treatments. A treatment containing a mixture of the individual AR homologues, at their natural abundance in rye bran, was prepared by combining 25.3% of C17:0, 32.0% of C19:0, 22.6% of C21:0, 12.5% of C23:0, and 7.6% of C25:0. The same procedure was carried out with 10 mM stock solutions of orcinol, α-tocopherol, and butylated hydroxytoluene (BHT) and all treatments were dried under a stream of nitrogen. Ethanol (1.0 mL) was added to the dried treatments (and a control treatment containing no antioxidant) and mixed with 10 g of melted ISO. The antioxidant activity of each treatment was tested at 153 μmol because this corresponds to 500 ppm of C21:0 in the final cracker which is a typical antioxidant concentration used in bakery applications.

### Example 6: Preparation of Crackers

Crackers were prepared according to the procedure described by Barden, Vollmer, Johnson, & Decker (2015) (Table 1).

TABLE 1
Cracker formulation.

| Ingredient | Mass (g) | Percentage (w/w) |
|---|---|---|
| ISO | 10.00 | 8.09 |
| Flour | 62.50 | 50.58 |
| Salt | 1.50 | 1.21 |
| Baking Soda | 0.58 | 0.47 |
| Water | 39.00 | 31.56 |
| Flour* | 10.00 | 8.09 |
| Total | 123.58 | 100.00 |

*Additional flour for sprinkling on baking mat when kneading

### Example 7

Antioxidant-treated ISO was melted at 90° C. for 10 minutes and mixed in a stand mixer (KSM95, KitchenAid, Benton Harbor, Mich., U.S.) using a beater blade for 1 minute (speed 2). Sifted flour, salt, and baking soda were added and mixed using a beater blade for 1 minute (speed 2). Water was added and mixed using a dough hook for 1 minute (speed 2). The additional flour was sprinkled onto the surface of a baking mat and incorporated into the dough by kneading by hand (30 folds). The dough was flattened by passing it through a pasta roller (KPSA, KitchenAid, Benton Harbor, Mich., U.S.) twice (thickness setting 2). The sheeted dough was cut into 2.5 cm×2.5 cm crackers and baked on an ungreased baking sheet for 9 minutes at 163° C. (FD 53-UL, Binder, Tuttlingen, Germany). After cooling to room temperature, crackers were coarsely crumbled using a mortar and pestle and weighed (0.5 g) into 10 mL amber glass headspace vials (Supelco Analytical, Bellefonte, Pa., U.S.), sealed with stainless steel screw caps with PTFE/silicone septa (Supelco Analytical, Bellefonte, Pa., U.S.), and allowed to autoxidize at 55° C. in the absence of light for up to 160 days. Crackers were analyzed for lipid hydroperoxides, headspace hexanal, and AR loss every 5 days for day 0-50, every 10 days for day 51-100, and every 20 days for the remainder of the storage time.

### Example 8: Measurement of Lipid Hydroperoxides

Lipid hydroperoxides were determined according to the method described by Shantha & Decker (1994) with slight modifications. Cracker samples (0.1 g) were finely ground using a mortar and pestle and mixed with 5.0 mL chloroform/methanol (2:1 (v/v)) by vortexing (10 seconds, 3 times). The hydroperoxide-containing lipid fraction was extracted and isolated by centrifugation at 2500×g for 10 minutes (Centrifuge 5702, A-4-38 Rotor, Eppendorf, Hamburg, Germany). To this extract (1.0 mL), 16.7 μL of an iron chloride solution (prepared by mixing 50 mL 66 mM FeSO₄ in water with 50 mL 38 mM BaCl₂ in 0.4 N HCl) was added followed by 16.7 μL of ammonium thiocyanate (3.9 M in water), and allowed to react at room temperature for 20 minutes. The absorbance of the samples was measured at 500 nm (GENESYS 180 UV-Vis Spectrophotometer, Thermo Fisher Scientific, Waltham, Mass., U.S.) and lipid hydroperoxides were quantified based on a standard curve prepared using cumene hydroperoxide.

### Example 9: Measurement of Headspace Hexanal

Cracker samples were prepared for GC-MS analysis by adding 10 μL of 100 mg/L 2-methypentanal (internal standard) in methanol directly through the capped headspace vial's septum. The GC system consisted of a 7890B gas chromatograph (Agilent, Santa Clara, Calif., U.S.) with sample introduction by means of an autosampler (Robotic MultiPurpose Sampler, Gerstel, Mülheim, Germany). Samples were equilibrated for 10 minutes at 55° C. with continuous shaking. A 50/30 μm divinylbenzene/carboxen/polydimethylsiloxane (DVB/CAR/PDMS) (1 cm) (Supelco Analytical, Bellefonte, Pa., U.S.) solid phase microextraction (SPME) fiber was exposed to the sample headspace for 2 minutes at 55° C. The SPME fiber was desorbed for 6 minutes at 250° C. in the injection port equipped with a SPME inlet liner at a split ratio of 10:1. Volatile aldehydes were separated on a Rtx-WAX capillary column (30 m, 0.25 mm i.d., 0.25 μm film thickness) (Restek, Bellefonte, Pa., U.S.). An oven program was followed to separate the different volatile aldehydes at a constant helium carrier gas flow rate of 1.22 mL/min. The oven program was as follows: hold at 40° C. for 1 minute; ramp at 10° C./min to 75° C.; ramp at 100° C./min to 250° C.; hold at 250° C. for 1.75 minutes. Detection and quantification of hexanal and 2-methylpentanal was achieved using a single quadrupole mass spectrometer (5977B, Agilent, Santa Clara, Calif., U.S.) coupled to the GC. The MS transfer line, quadrupole, and detector temperatures were set to 250° C., 230° C., 150° C., respectively. Mass spectra were collected in electron impact mode. Scan mode was used to monitor from 33 to 350 m/z with 8.1 scans/sec and selective ion monitoring was used to monitor ions with m/z of 56.0, 58.0, 71.0, and 82.0 with a dwell time of 60 msec each. Headspace hexanal was quantified based on a standard curve prepared by spiking cracker samples with known concentrations of hexanal. Hexanal was expressed relative to 2-methylpentanal using the integrated peak areas of the selected ion monitoring chromatograms.

### Example 10: Measurement of Alkylresorcinol Loss in Crackers

ARs were extracted from the crackers that were treated with the mixture of individual AR homologues. Cracker samples (0.15 g) were finely ground using a mortar and pestle and mixed with 1.0 mL of 185 μM orcinol (internal standard) and 200 μM BHT (to inhibit sample degradation) in methanol. ARs were extracted by sonicating for 30 minutes (3510 Ultrasonic Cleaner, Branson Ultrasonics, Brookfield, Conn., U.S.).

### Example 11: Preparation for HPLC Analysis

Samples were prepared for HPLC analysis by filtering them over PTFE syringe filter tips (0.45 μm). The HPLC system consisted of a quaternary pumping system (G1311A, Agilent, Santa Clara, Calif., U.S.) with high-pressure mixing and sample introduction by means of an autosampler (G1329A, Agilent, Santa Clara, Calif., U.S.). AR homologues were separated on an Eclipse Plus C18 column (5 μm, 2.1×150 mm) (Agilent, Santa Clara, Calif., U.S.) held at 35° C. The mobile phase consisted of 0.1% (v/v) formic acid in water (A) and 0.1% (v/v) formic acid in methanol (B). A gradient program was followed to separate the different AR homologues at a flow rate of 0.2 mL/min. The gradient program was as follows: 0 minutes, 90% B; 0-10 minutes, 100% B; 10-25 minutes, 100% B; 25-25.5 minutes, 90% B; 25.5-35 minutes, 90% B (Gunenc et al., 2015). Detection and quantification of the AR homologues was achieved using a UV-Vis detector (G1315B, Agilent, Santa Clara, Calif., U.S.) at 280 nm and a fluorescence detector (G1321A, Agilent, Santa Clara, Calif., U.S.) with an excitation wavelength of 276 nm and emission wavelength of 306 nm. AR homologues were quantified relative to orcinol using the integrated peak areas of the fluorescence chromatograms. These relative peak areas were expressed relative to the relative peak area at time zero to plot the AR loss curves.

### Example 12: Statistical Analysis

All experiments were performed in triplicate on separately prepared cracker samples. Statistical analysis was performed using a one-way ANOVA with Tukey's Honestly Significant Difference post-hoc test (Minitab, State College, Pa., U.S.) (α=0.05). All data was normally distributed as determined by a normality test (α=0.05).

An alternative explanation for the strong antioxidant activity of the AR Mix treatment is that the AR homologues might interact in a way that improves their overall efficacy as a mixture. When screening the antioxidant activity of a mixture of ARs (C15:0-C25:0) at their natural abundance in wheat bran, a synergistic effect was reported for the mixture given its higher radical scavenging capacity than the individual AR homologues (Gunenc, HadiNezhad, Tamburic-Ilincic, Mayer, & Hosseinian, 2013). While antioxidant interactions were not explicitly tested in either study, results from both suggest that individual AR homologues might behave in a synergistic manner when used in combination. Future work should formally test their interactions as antioxidants in a variety of foods and develop a model to explain this behavior.

Antioxidant Activities of Individual Alkylresorcinol Homologues in Crackers

Individual AR homologues (C17:0, C19:0, C21:0, C23:0, C25:0) were added separately and as a mixture (AR Mix) to ISO and subsequently incorporated into the cracker samples. The antioxidant activities of the AR homologues in crackers were compared to orcinol (a water-soluble AR), conventional antioxidants (i.e., α-tocopherol, BHT), and a control treatment (i.e., no added antioxidant). The crackers were allowed to autoxidize in the absence of light and primary (i.e., lipid hydroperoxides) and secondary products (i.e., headspace hexanal) of lipid oxidation were measured as a function of time.

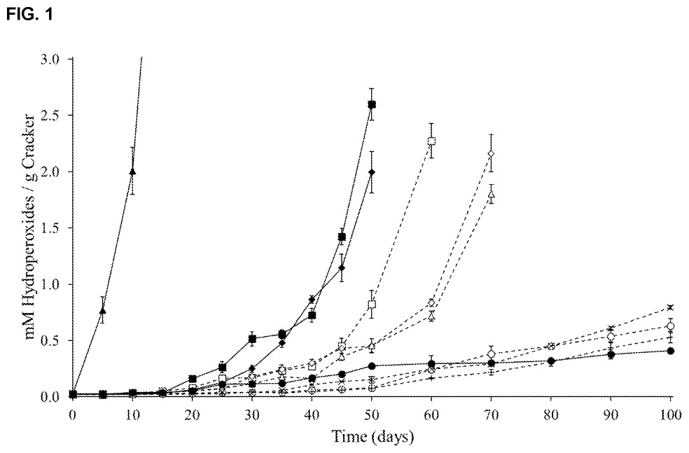

The α-tocopherol-treated crackers began to accumulate lipid hydroperoxides immediately upon storage while the control crackers and other treatments remained in the lag phase of lipid oxidation indicating prooxidant activity of α-tocopherol (FIG. 1). After day 15, the control crackers showed a rapid increase in lipid hydroperoxides while the other treatments remained in the lag phase, demonstrating their ability to function as antioxidants in this system (FIG. 1).

Beginning on day 25, the orcinol, C17:0, C19:0, C21:0, and BHT-treated crackers showed an increase in the concentration of lipid hydroperoxides with the orcinol treatment oxidizing most rapidly followed by the C17:0 treatment and then the C19:0 and C21:0 treatments (FIG. 1). While those treatments displayed a rapid formation of lipid hydroperoxides at subsequent time points, the BHT-treated crackers displayed a slow, steady increase in lipid hydroperoxide concentration over the duration of the study (FIG. 1). After day 50, the C23:0, C25:0, and AR Mix-treated crackers displayed a slow, steady increase in lipid hydroperoxide concentration over the remainder of the storage time with the C25:0 treatment oxidizing most rapidly (FIG. 1).

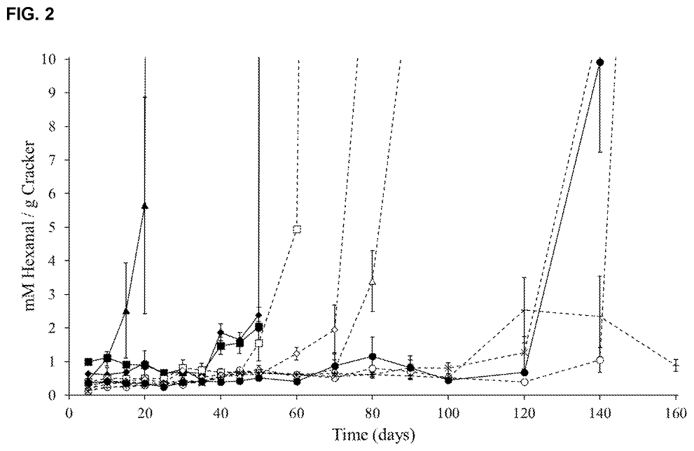

Hexanal was not detected in any of the cracker samples until day 5 (FIG. 2). Beginning on day 5, the α-tocopherol-treated crackers showed a rapid increase in hexanal while the control crackers and other treatments remained in the lag phase of lipid oxidation further indicating α-tocopherol's prooxidant behavior (FIG. 2). After day 35, the control and orcinol-treated crackers began to accumulate hexanal with no difference in the concertation of hexanal between them at subsequent time points indicating that orcinol has neither prooxidant or antioxidant activity (FIG. 2). The other treatments functioned as antioxidants by extending the lag phase before the formation of secondary products of lipid oxidation. On day 45, 50, and 70, C17:0, C19:0, and C21:0-treated crackers showed an increase in the concentration of hexanal, respectively, which continued to increase rapidly at subsequent time points (FIG. 2). After day 100, the AR Mix-treated crackers showed an increase in the concentration of hexanal with minimal changes at subsequent time points while the C25:0 and BHT-treated crackers displayed a rapid formation of hexanal after day 120 (FIG. 2). The C23:0-treated crackers had low levels of hexanal over the entire storage time suggesting that this treatment was still in the lag phase of lipid oxidation at the conclusion of the study (FIG. 2).

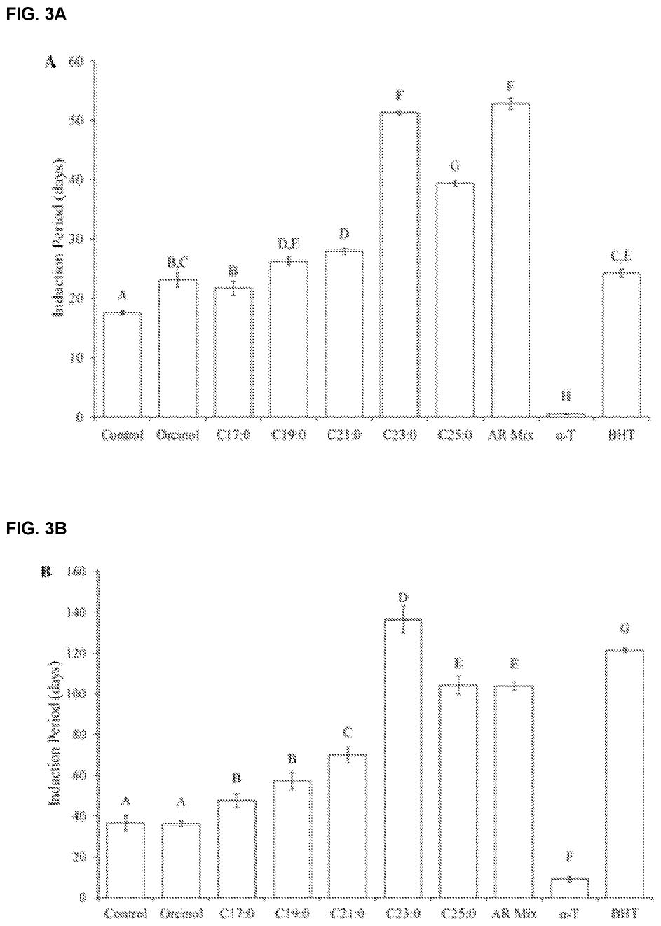

The induction period before the onset of lipid oxidation in crackers was defined as the time to reach a critical threshold concentration of primary ([Hydroperoxides]=0.1 mM/g cracker) and secondary products ([Hexanal]=1.0 mM/g cracker) of lipid oxidation. For lipid hydroperoxides, the order of induction periods was AR Mix≈C23:0>C25:0>(C21:0≈C19:0)>(C19:0≈BHT)>(BHT≈orcinol)>(orcinol≈C17:0)>control>>α-tocopherol (FIG. 3A). For headspace hexanal, the order of induction periods was C23:0>BHT>C25:0 AR Mix>C21:0>C19:0≈C17:0>control≈orcinol>>α-tocopherol (FIG. 3B).

The antioxidant activity of ARs increased as alkyl chain length increased, with optimum activity at an alkyl chain length of C23:0. This follows the same general trend reported by Barden, Barouh, et al. (2015), who observed that antioxidant activity increased with increasing alkyl chain length for rosmarinic acid and a pair of rosmarinate alkyl esters in the same low-moisture model cracker system. The hydrophobic AR homologues derived from rye bran displayed stronger antioxidant activity than the hydrophilic homologue orcinol, which displayed weak to no antioxidant activity in the model cracker system. This is also in agreement with the results of the previous study by Barden, Barouh, et al., (2015) who observed that that the hydrophilic rosmarinic acid displayed weak antioxidant and prooxidant activity against the formation of lipid hydroperoxides and hexanal, respectively.

The Inventors have previously used an oxygen radical absorbance capacity assay to show that the radical scavenging capacity of AR homologues decreases as alkyl chain increases with orcinol displaying the strongest antiradical activity (Elder et al., 2021). However, the effect of alkyl chain length on the radical scavenging capacity does not align with the trend of the antioxidant activity of AR homologues seen in the low-moisture model cracker system indicating that another factor, presumably related to the effects of food physical structure, is responsible for the observed antioxidant activity of ARs in the model cracker system. Barden, Barouh, et al. (2015) used confocal microscopy to show that rosmarinic acid (i.e., an ineffective antioxidant) localized outside of the lipid phase in the model cracker system due to its low lipid solubility while the rosmarinate alkyl esters (i.e., effective antioxidants) were highly associated with the lipid phase. Similarly, the poor antioxidant activity of orcinol, despite its high radical scavenging capacity, is likely due to its hydrophilic nature resulting in it concentrating at phases other than the lipid phase. In contrast, the strong antioxidant activity of the AR homologues, especially C23:0 and C25:0, despite their low radical scavenging capacity, is likely due to their hydrophobic nature resulting in them concentrating at the lipid phase, the purported site of lipid oxidation in the model cracker system.

α-Tocopherol is a commonly used natural antioxidant but here it displayed strong prooxidant activity in the low-moisture model cracker system. This is in contrast to previous research which has shown that α-tocopherol is a more effective antioxidant than ARs in other food systems such as bulk oils and oil-in-water emulsions (Elder et al., 2021; Kamal-Eldin, Pouru, Eliasson, & Aman, 2001). The prooxidant activity of α-tocopherol in this work may be due to its usage level.

While α-tocopherol typically functions as an antioxidant, it has been shown to display prooxidant behavior at high concentrations. This is due to regeneration of α-tocopherol from tocopheroxyl radicals by lipid hydroperoxides which, in turn, forms peroxyl radicals that subsequently initiate further lipid oxidation reactions (Huang, Frankel, & German, 1994). In whole-wheat bread, loaves enriched with high levels of α-tocopherol (1 g/kg flour) had pronounced rancid aroma and rancid flavor according to sensory analysis and higher levels of lipid hydroperoxides and volatile secondary products of lipid oxidation compared to control loaves (i.e., without added antioxidant) (Jensen, Ostdal, Skibsted, & Thybo, 2011). This effect was also observed in cookies and puffed rice snacks when tocopherols were added at 100-200 ppm (Jensen et al., 2011; Ochi et al., 1993; Park, Kim, & Shin, 2002). In contrast, when used at low concentrations (˜18 ppm), α-tocopherol inhibited the formation of primary and secondary products of lipid oxidation in whole-wheat breads indicating antioxidant activity (Osuna, Romero, Romero, Judis, & Bertola, 2018). In this application, α-tocopherol was added to the crackers at 500 ppm; therefore, its prooxidant behavior is likely a result of its usage at a high concentration.

BHT is a commonly used synthetic antioxidant that displayed strong antioxidant activity in the low-moisture model cracker system which is in agreement with previous research (Barden, Barouh, et al., 2015). BHT was a more effective antioxidant than some of the individual AR homologues (i.e. C17:0, C19:0, C21:0) which has been observed in other food systems such as bulk oils and oil-in-water emulsions (Elder et al., 2021). The lower efficacy of ARs as compared to BHT has been attributed to the meta substitution of their phenolic ring (Sroka & Cisowski, 2003).

Loss of Individual Alkylresorcinol Homologues in Crackers

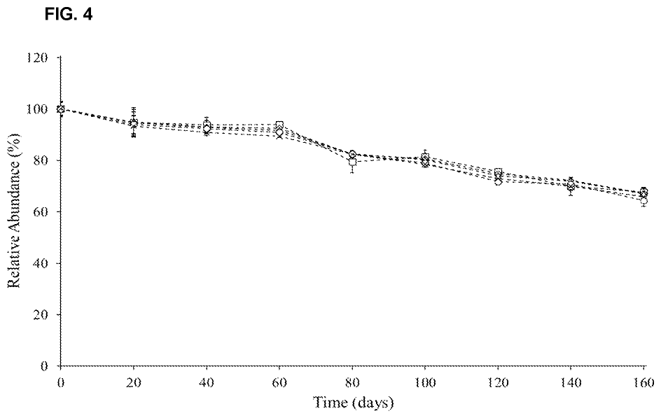

The loss of AR homologues was measured in the AR Mix-treated cracker samples over the course of the lipid oxidation study. The relative abundance of all of the AR homologues in the AR Mix-treated cracker samples decreased at a similar, constant rate over the entire storage time (FIG. 4), independent of chain length.

There is no effect of alkyl chain length on the rate of loss of ARs with ˜75% of each individual AR homologue remaining at day 120 when the AR Mix-treated crackers began to accumulate hexanal. This does not follow the general trend reported by Barden, Barouh, et al., (2015), who observed that rosmarinic acid and the rosmarinate alkyl esters were lost prior to hexanal formation and their rate of loss decreased with increasing alkyl chain length in the same low-moisture model cracker system. The authors hypothesized that differences in the rate of loss of the rosmarinate alkyl esters were due to differences in their localization and, thus, their availability to interact with other food components (e.g. transition metals) (Barden, Barouh, et al., 2015). Rosmarinic acid and the dodecyl ester were lost more rapidly because they localized to other phases than the lipid phase where they could readily interact with transition metals, degrading the antioxidants (Barden, Barouh, et al., 2015). In contrast, the eicosyl ester was lost more slowly because it was concentrated at the lipid phase making it unable to interact with transition metals, preserving the antioxidant to scavenge free radicals, thus improving its antioxidant activity (Barden, Barouh, et al., 2015).

The similar rate of loss of the AR homologues in the present work suggests that they are all localized to the same phase of the low-moisture model cracker system where they are susceptible to the same interactions and reactions. Moreover, the fact that such a large percentage of the AR homologues remained in their native, unoxidized state, even at advanced stages of lipid oxidation, suggests that only a small portion of the ARs were concentrated at the lipid phase and consumed as antioxidants while protecting the lipid while the remaining majority of ARs were localized in other, oxidatively inert phases where they could not prevent lipid oxidation reactions. This inert phase is presumably the non-lipid portions of the cracker where low molecular mobility limits the interaction of the ARs with transition metals and protects them from oxidative loss.

Differences in the antioxidant activity between the individual AR homologues could also be due to differences in the concentration of each homologue localized at the lipid phase. For the previously discussed rosmarinic acid and rosmarinate alkyl esters, it was hypothesized that the eicosyl ester displayed the strongest antioxidant activity because it had the highest solubility in the lipid phase due to its hydrophobicity (Barden, Barouh, et al., 2015). The eicosyl ester's greater hydrophobicity resulted in a higher concentration of this ester in the lipid phase, concentrating the antioxidant at the purported site of lipid oxidation (Barden, Barouh, et al., 2015). For the individual AR homologues, antioxidant activity increased as hydrophobicity increased (i.e., activity increased as alkyl chain length increased). Therefore, the more hydrophobic, long alkyl chain AR homologues (C23:0, C25:0) likely have higher solubility in the lipid phase, resulting in higher concentrations of these AR homologues at the purported site of lipid oxidation, thus, giving rise to stronger antioxidant activity than the less hydrophobic, shorter alkyl chain AR homologues (C17:0, C19:0, C21:0), despite their lower radical scavenging capacity.

This partitioning hypothesis could explain the strong antioxidant activity of the AR Mix treatment. It was expected that the AR Mix treatment would have similar antioxidant activity to the C17:0, C19:0, and C21:0 treatments since the mixture is predominately (˜80%) these three homologues. The AR Mix treatment displayed stronger antioxidant activity than these individual AR homologues and was comparable in activity to the C23:0 and C25:0 treatments despite having a fraction of these homologues in the mixture, these homologues only making up 12.5% and 7.6% of the AR Mix treatment, respectively. The stronger antioxidant activity of the AR Mix treatment could arise from the long alkyl chain homologues (C23:0, C25:0) that concentrate at the purported site of lipid oxidation, improving the antioxidant activity of the AR Mix treatment as a whole.

ARs (153 μmol) were found to be capable of inhibiting lipid oxidation reactions based on the delayed generation of lipid hydroperoxides and headspace hexanal compared to a control treatment, and were more effective than α-tocopherol which displayed prooxidant behavior.

This application shows AR homologues were able to slow the rate of lipid oxidation in a model low-moisture model food (i.e., a cracker). The antioxidant activity of ARs increased as their alkyl chain length increased, with optimum activity at an alkyl chain length of C23:0. ARs were consumed during the oxidation at a rate independent of alkyl chain length, however, a majority of ARs remained in the cracker even at advanced stages of lipid oxidation. These results suggest that only a fraction of the ARs were localized at the lipid phase in the model cracker system where they were able to inhibit oxidation while the remainder was inactive the oxidatively inert non-lipid portion of the cracker. Additionally, the more hydrophobic longer alkyl chain AR homologues (C23:0, C25:0) were likely more concentrated at the lipid phase giving rise to stronger antioxidant activity despite their lower radical scavenging capacity. All of the AR homologues were more effective than α-tocopherol which displayed prooxidant activity. The C23:0, C25:0, and AR Mix treatments displayed comparable antioxidant activities, and were also more effective than BHT at increasing the induction period before the onset of lipid oxidation, providing an effective alternative to synthetic antioxidants.

AR homologues have been shown to exert antioxidant activity in a variety of food systems with alkyl chain length affecting their activity differently depending on the system (i.e., bulk oils, emulsions, and low-moisture foods such as crackers) (Elder et al., 2021). This unique property of ARs provides versatility for the food industry to select homologues that exert optimal antioxidant activity for a given food application which cannot be achieved through the use of other conventional antioxidants. Additionally, a mixture of ARs, without isolation of the individual homologues, has been found to have the potential to be an alternative to synthetic antioxidants in low-moisture foods.

ARs are thus natural antioxidants, comprising a homologous series of phenolipids found in the bran layer of a variety of grains. Since ARs exist as a homologous series, certain homologues exhibit increased antioxidant activity in emulsified foods as they can partition to the lipid droplet surface (i.e. the site of oxidation) due to their amphiphilic nature.

### CITED DOCUMENTS

All documents cited herein including those below are hereby incorporated by reference in their entirety. To the extent anything in these documents contradicts this written specification, this specification controls.
Arab-Tehrany, E., Jacquot, M., Gaiani, C., Imran, M., Desobry, S., & Linder, M. (2012). Beneficial effects and oxidative stability of omega-3 long-chain polyunsaturated fatty acids. Trends in Food Science & Technology, 25(1), 24-33.
Barden, L., Barouh, N., Villeneuve, P., & Decker, E. A. (2015). Impact of Hydrophobicity on Antioxidant Efficacy in Low-Moisture Food. Journal of Agricultural and Food Chemistry, 63(24), 5821-5827.
Barden, L., & Decker, E. A. (2016). Lipid Oxidation in Low-moisture Food: A Review. Critical Reviews in Food Science and Nutrition, 56(15), 2467-2482.
Barden, L., Vollmer, D., Johnson, D., & Decker, E. A. (2015). Impact of Iron, Chelators, and Free Fatty Acids on Lipid Oxidation in Low-Moisture Crackers. Journal of Agricultural and Food Chemistry, 63(6), 1812-1818.
Bartlomiej, S., Justyna, R.-K., & Ewa, N. (2012). Bioactive compounds in cereal grains—occurrence, structure, technological significance and nutritional benefits—a review. Food Science and Technology International, 18(6), 559-568.
Brewer, M. S. (2011). Natural Antioxidants: Sources, Compounds, Mechanisms of Action, and Potential Applications. Comprehensive Reviews in Food Science and Food Safety, 10(4), 221-247.
Chen, B., McClements, D. J., & Decker, E. A. (2011). Minor Components in Food Oils: A Critical Review of their Roles on Lipid Oxidation Chemistry in Bulk Oils and Emulsions. Critical Reviews in Food Science and Nutrition, 51(10), 901-916.
Choe, E., & Min, D. B. (2009). Mechanisms of Antioxidants in the Oxidation of Foods. Comprehensive Reviews in Food Science and Food Safety, 8(4), 345-358.
Elder, A. S., Coupland, J. N., & Elias, R. J. (2019). Antioxidant activity of a winterized, acetonic rye bran extract containing alkylresorcinols in oil-in-water emulsions. Food Chemistry, 272, 174-181.
Elder, A. S., Coupland, J. N., & Elias, R. J. (2021). Effect of alkyl chain length on the antioxidant activity of alkylresorcinol homologues in bulk oils and oil-in-water emulsions. Food Chemistry, 346, 128885.
Frankel, E. N. (1998). Lipid oxidation (1st ed.). Dundee, Scotland: The Oily Press.
Frankel, E. N., Huang, S.-W., Kanner, J., & German, J. B. (1994). Interfacial Phenomena in the Evaluation of Antioxidants: Bulk Oils vs Emulsions. Journal of Agricultural and Food Chemistry, 42(5), 1054-1059.
Ganesan, B., Brothersen, C., & McMahon, D. J. (2014). Fortification of Foods with Omega-3 Polyunsaturated Fatty Acids. Critical Reviews in Food Science and Nutrition, 54(1), 98-114.
Gülçin, I. (2012). Antioxidant activity of food constituents: an overview. Archives of Toxicology, 86(3), 345-391.
Gunenc, A., HadiNezhad, M., Farah, I., Hashem, A., & Hosseinian, F. (2015). Impact of supercritical CO2 and traditional solvent extraction systems on the extractability of alkylresorcinols, phenolic profile and their antioxidant activity in wheat bran. Journal of Functional Foods, 12, 109-119.
Gunenc, A., HadiNezhad, M., Tamburic-Ilincic, L., Mayer, P. M., & Hosseinian, F. (2013). Effects of region and cultivar on alkylresorcinols content and composition in wheat bran and their antioxidant activity. Journal of Cereal Science, 57(3), 405-410.
Gupta, M. K. (2017) Practical guide to vegetable oil processing (2nd ed.). Cambridge, Mass.: AOCS Press.
Hengtrakul, P., Lorenz, K., & Mathias, M. (1991). Alkylresorcinol Homologs in Cereal Grains. Journal of Food Composition and Analysis, 4(1), 52-57.
Huang, S.-W., Frankel, E. N., & German, J. B. (1994). Antioxidant Activity of α- and γ-Tocopherols in Bulk Oils and in Oil-in-Water Emulsions. Journal of Agricultural and Food Chemistry, 42(10), 2108-2114.
Huth, P. J., Fulgoni III, V. L., Keast, D. R., Park, K., & Auestad, N. (2013). Major food sources of calories, added sugars, and saturated fat and their contribution to essential nutrient intakes in the U.S. diet: data from the national health and nutrition examination survey (2003-2006). Nutrition Journal, 12, 116.
Jacobsen, C., Let, M. B., Nielsen, N. S., & Meyer, A. S. (2008). Antioxidant strategies for preventing oxidative flavour deterioration of foods enriched with n-3 polyunsaturated lipids: a comparative evaluation. Trends in Food Science & Technology, 19(2), 76-93.
Jensen, S., Ostdal, H., Skibsted, L. H., & Thybo, A. K. (2011). Antioxidants and shelf life of whole wheat bread. Journal of Cereal Science, 53(3), 291-297.
Kamal-Eldin, A., Pouru, A., Eliasson, C., & Aman, P. (2001). Alkylresorcinols as antioxidants: hydrogen donation and peroxyl radical-scavenging effects. Journal of the Science of Food and Agriculture, 81(3), 353-356.
Kanner, J. (2007). Dietary advanced lipid oxidation endproducts are risk factors to human health. Molecular Nutrition & Food Research, 51(9), 1094-1101.
Keast, D. R., Fulgoni III, V. L., Nicklas, T. A., & O'Neil, C. E. (2013). Food Sources of Energy and Nutrients among Children in the United States: National Health and Nutrition Examination Survey 2003-2006. Nutrients, 5(1), 283-301.
Kittipongpittaya, K., Panya, A., Phonsatta, N., & Decker, E. A. (2016). Effects of Environmental pH on Antioxidant Interactions between Rosmarinic Acid and α-Tocopherol in Oil-in-Water (O/W) Emulsions. Journal of Agricultural and Food Chemistry, 64(34), 6575-6583.
Laguerre, M., Bayrasy, C., Panya, A., Weiss, J., McClements, D. J., Lecomte, J., . . . Villeneuve, P. (2015). What Makes Good Antioxidants in Lipid-Based Systems? The Next Theories Beyond the Polar Paradox. Critical Reviews in Food Science and Nutrition, 55(2), 183-201.
Leong, W. F., Berton-Carabin, C. C., Elias, R. J., Lecomte, J., Villeneuve, P., Zhao, Y. Coupland, J. N. (2015). Effect of lipophilization on the distribution and reactivity of ingredients in emulsions. Journal of Colloid and Interface Science, 459, 36-43.
Mozaffarian, D., Micha, R., & Wallace, S. (2010). Effects on Coronary Heart Disease of Increasing Polyunsaturated Fat in Place of Saturated Fat: A Systematic Review and Meta-Analysis of Randomized Controlled Trials. PLOS Medicine, 7(3), e1000252.
Ochi, T., Tsuchiya, K., Ohtsuka, Y., Aoyama, M., Maruyama, T., & Niiya, I. (1993). Synergistic Antioxidant Effects of Organic Acids and their Derivatives with Tocopherols on Cookies. Nippon Shokuhin Kogyo Gakkaishi.
Osuna, M. B., Romero, C. A., Romero, A. M., Judis, M. A., & Bertola, N. C. (2018). Proximal composition, sensorial properties and effect of ascorbic acid and α-tocopherol on oxidative stability of bread made with whole flours and vegetable oils. LWT—Food Science and Technology, 98, 54-61.
Park, Y. S., Kim, Y. S., & Shin, D. H. (2002). Antioxidative Effects of Ethanol Extracts from Rhus verniciflua Stoke on Yukuma (Oil Popped Rice Snack) Base During Storage. Journal of Food Science, 67(7), 2474-2479.
Pazos, M., Torres, J. L., Andersen, M. L., Skibsted, L. H., & Medina, I. (2009). Galloylated polyphenols efficiently reduce α-tocopherol radicals in a phospholipid model system composed of sodium dodecyl sulfate (SDS) micelles. Journal of Agricultural and Food Chemistry, 57(11), 5042-5048.
Reedy, J., & Krebs-Smith, S. M. (2010). Dietary Sources of Energy, Solid Fats, and Added Sugars among Children and Adolescents in the United States. Journal of the American Dietetic Association, 110(10), 1477-1484.
Shan, Z., Rehm, C. D., Rogers, G., Ruan, M., Wang, D. D., Hu, F. B., . . . Bhupathiraju, S. N. (2019). Trends in Dietary Carbohydrate, Protein, and Fat Intake and Diet Quality Among US Adults, 1999-2016. Journal of the American Medical Association, 322(12), 1178-1187.
Shantha, N. C., & Decker, E. A. (1994). Rapid, Sensitive, Iron-Based Spectrophotometric Methods for Determination of Peroxide Values of Food Lipids. Journal of AOAC International, 77(2), 421-424.
Sroka, Z., & Cisowski, W. (2003). Hydrogen peroxide scavenging, antioxidant and anti-radical activity of some phenolic acids. Food and Chemical Toxicology, 41(6), 753-758.
Waraho, T., McClements, D. J., & Decker, E. A. (2011). Mechanisms of lipid oxidation in food dispersions. Trends in Food Science & Technology, 22(1), 3-13.

Although embodiments been described in terms of specific exemplary embodiments and examples, it will be appreciated that the embodiments disclosed herein are for illustrative purposes only and various modifications and alterations might be made by those skilled in the art without departing from the spirit and scope of the disclosure as set forth in the following claims.

1. An antioxidant composition comprising:
(i) a compound of Formula (I): 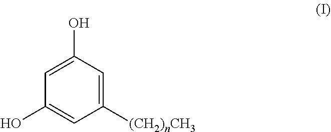
comprising an alkyl chain wherein n=12-26; and
(ii) a low-moisture food;
wherein the low-moisture food has a water activity (a_{w}) equal to or less than 0.85.

2. The composition of claim 1, wherein the low-moisture food is manufactured.

3. The composition of claim 1, wherein the compound of Formula (I) is isolated, purified, and/or extracted.

4. The composition of claim 1, wherein the compound of Formula (I) is obtained by a winterization process.

5. The composition of claim 1, wherein the natural abundance of the compound of Formula (I) is between 0.004% to 0.32% alkylresorcinols per unit of dry matters low.

6. The composition of claim 1, wherein n is 12-20 or 22-26.

7. The composition of claim 1, comprising a mixture of compounds of Formula (I).

8. The composition of claim 1, wherein the mixture comprises compounds of Formula (I) in which n=is 12, 14, 16, 18, 20, 22, 24, or 26.

9. The composition of claim 1, wherein n=14-20, preferably, n=14, 16, 18, or 20.

10. The composition according to claim 1, wherein the low moisture food is selected from the group consisting of cookies, crackers, granola bars, breakfast cereals, grains, confectionary, dairy and egg powders, dried fruits, vegetables, meats, honey, seeds, nuts, peanut butter, chips, corn chips, potato chips, and spices.

11. The composition according to claim 1, wherein the a_{w} is 0.6 or less.

12. The composition according to claim 1, comprising more than one compound of Formula (I).

13. The composition according to claim 1, wherein the alkyl chain length is C₂₁₋₂₃.

14. The composition according to claim 1, further comprising a second type of antioxidant.

15. The composition according to claim 1, wherein the alkyl chain in the compound of Formula (I) is further substituted.

16. The composition according to claim 1, utilizing the composition as a preservative.

17. A method of preparing the compound of Formula (I) according to claim 1 by winterization, comprising:
(i) extracting crude alkylresorcinols from rye bran;
(ii) removing bran solids to produce a crude rye bran extract;
(iii) reconstituting the crude rye bran extract in asolvent;
(iv) centrifuging and retaining a supernatant formed;
(v) storing the supernatant at conditions causing the crude alkylresorcinols to crystallize
(vi) centrifuging and retaining a pellet formed;
(vii) reconstituting the pellet in alcohol;
optionally repeating steps (i)-(vii) one or more times;
and optionally drying the pellet produced by step (vii).

18. The method according to claim 17, wherein the (i) extracting step uses acetone at a ratio of 1:40 (w/v) by continuous stirring at room temperature for 24 hours; and optionally the acetone is evaporated from the extract to dryness.

19. A low-moisture food obtainable by the method of claim 17, wherein the compound of formula (I) has a C₁₇₋₂₅ alkyl chain, and is optionally further isolated from the winterized rye bran extract using preparative HPLC.

20. A food product comprising the composition according to claim 1.
